(19) United States
(12) Patent Application Publication
(10) Pub. No.: US 2026/0306979 A1
(43) Pub. Date: Oct. 8, 2026

(54) FILTER MATERIAL, METHOD FOR PRODUCING THE FILTER MATERIAL, AND USE OF MELT-BLOWN POLYPROPYLENE FIBERS

(71) Applicant: Carl Freudenberg KG, Weinheim (DE)

(72) Inventors: Heiko SCHACHT, Weinheim (DE); Rosemarie KURZER, Burgen (DE); Jochen HERMANN, Reichenbach-Steegen (DE); Oliver STAUDENMAYER, Weinheim (DE)

(21) Appl. No.: 19/637,019

(22) Filed: Apr. 2, 2026

(30) Foreign Application Priority Data
Apr. 3, 2025 (EP) 25168276.1

(51) Int. Cl. B01D 39/16

(52) U.S. Cl. CPC B01D 39/1623; B01D 2239/0622; B01D 2239/064; B01D 2239/065; B01D 2239/1233; B01D 2239/1291

(57) ABSTRACT

The disclosure relates to a filter material comprising a first layer, comprising melt-blown polypropylene fibers, wherein the polypropylene fibers have a fiber diameter in a range from 400 nm to 600 nm at a relative frequency, as determined by means of the method disclosed in the description, of at least 20%, and a fiber diameter in a range from >600 nm to 800 nm at a relative frequency, as determined by means of the method disclosed in the description, of at least 20%.

### CROSS REFERENCE TO RELATED APPLICATIONS

The present application claims priority to European patent application No. EP25168276.1, which was filed on Apr. 3, 2025, and which is incorporated herein by reference in its entirety.

### FIELD

The present disclosure relates to a filter material having a high filter action and a low increase in pressure difference, and also to a method for producing such a filter material. The present disclosure also relates to the use of melt-blown polypropylene fibers.

### BACKGROUND

At the present time, air-permeable and gas-permeable filter materials, as described, for example, in WO 2019/213107 A1, are commonly equipped with nanofiber layers in order to be able to achieve high particle separation performance. However, the high efficiency of such filter materials results in a sudden increase in pressure difference with the filter material becoming blocked, and thus results in a disadvantageously high replacement rate.

Proceeding from the aforementioned prior art, it is therefore an object of the present disclosure to provide a filter material which is characterized by very good filter performance, i.e., in general high efficiency and advantageously also a high particle separation rate, and also by an increased separation capacity, in particular a high dust loading capacity with a low increased pressure drop and, as a result, a longer service life and longer intervals between replacements.

This object is achieved by the features of the independent claims. The dependent claims contain advantageous developments and configurations of the filter material of the present disclosure.

Accordingly, the present disclosure relates to a filter material having a first layer that comprises melt-blown polypropylene fibers.

Against this background, it is an object of the present disclosure to provide a new process for producing a catalyst-containing electrode layer on a substrate, in particular a catalyst layer for fuel cells or other chemical or electrochemical reactors, which can be carried out cost-effectively and quickly with simultaneously good catalyst utilization and distribution, and which has further advantages which are explained in more detail below.

### SUMMARY

In the context of the present disclosure, a filter material means a layered material, which is used as a filter medium, for example after assembly, i.e., after adjustment of the size and possibly layering to give a multilayer assembly. The filter material can also be used in filter cassettes and, for example, as a replacement filter. The filter material according to the disclosure is used in particular in the air filter sector, both in buildings and in short-distance and long-distance passenger transport, for instance in buses and trains, on ships and in aircraft, but is not limited thereto and can also be used as a fluid filter, for instance as a water filter or gas filter, for instance soot particulate filters or in air conditioning systems.

Melt-blown polypropylene fibers (hereinafter also referred to as PP fibers) are used for the filter material according to the disclosure, and more specifically for the first layer of the filter material. In comparison with other plastics-based fibers, melt-blown PP fibers have the advantage of having high mechanical and chemical stability. Melt blowing is a process in which an extruded polymer melt is stretched into fine fibers by interacting with hot air, achieving a uniform fiber structure. A thermoplastic fiber-forming polymer is extruded and, as it leaves the spinnerets, is guided into a high-speed stream of hot air (usually over 250° C.). The high-speed stream of hot air usually emerges near to the spinneret holes and guides the extruded polymer flows. The stretching results in very fine filaments depending on the prevailing temperature and the volume of air. The filaments are usually deposited on a lay-down belt or a lay-down drum, resulting in a fine, typically self-bonded, nonwoven web. Melt blowing differs from conventional spunbonding technology, in which, unlike in melt blowing, the fibers are not drawn out using high-speed streams of air. Specifically, in conventional spunbonding technology, the filaments emerging from the spinnerets are first cooled, moderately stretched using air, and laid on a collecting belt. Considerably coarser fiber diameters are formed than in the melt-blowing process, and the material is usually consolidated by subsequent calendering. The melt-blowing method is well known and described in various patents and publications, for example Naval Research Laboratory (NRL) report 4364, “Herstellung von superfeinen organischen Fasern” [The production of superfine organic fibers] by V. A. Wendt, E. L. Boone and C. D. Fluharty; NRL report 5265, “Eine verbesserte Vorrichtung für die Bildung von superfeinen Thermoplastic Fibers” [An improved device for forming superfine thermoplastic fibers] by K. D. Lawrence, R. T. Lukas, and J. A. Junge; and U.S. Pat. No. 3,849,241, granted on Nov. 19, 1974 to Buntin et al. These documents are thus incorporated herein by reference.

The use of polypropylene has proved particularly advantageous because it is cheap and widely available, has an electrical constant within the preferred range, and thus can be readily electrostatically charged. The melt-blowing process makes it possible to produce submicron PP fibers which can be laid on a suitable supporting surface, optionally on a substrate.

The melt-blown PP fibers used for the filter material according to the disclosure have a fiber diameter in a range from 400 nm to 600 nm at a relative frequency, as determined by means of the method disclosed in the description, of at least 20%, for example from 20% to 60%, and a fiber diameter in a range from >600 nm to 800 nm at a relative frequency, as determined by means of the method disclosed in the description, of at least 20%, for example from 20% to 60%.

According to the disclosure, it is preferred for the polypropylene fibers to have a fiber diameter in a range from 400 nm to 600 nm at a relative frequency, as determined by means of the method disclosed in the description, of at least 25%, for example from 25% to 60%, preferably from 25% to 55%, more preferably from 30% to 50%, in particular from 35% to 45%. The determination of the relative frequency of the fiber diameter is described in the “Measurement Methods and Standards” section.

According to the disclosure, it is also preferred for the polypropylene fibers to have a fiber diameter in a range from >600 nm to 800 nm at a relative frequency, as determined by means of the method disclosed in the description, of from 20% to 50%, more preferably from 20% to 40%, in particular from 25% to 35%.

Further preferably, the polypropylene fibers have a fiber diameter in a range from 400 nm to 575 nm at a relative frequency, as determined by means of the method disclosed in the description, of at least 20%, for example from 20% to 60%, preferably of at least 25%, for example from 25% to 60%, more preferably from 25% to 55%, more preferably from 30% to 50%, in particular from 35% to 45%.

Further preferably, the polypropylene fibers have a fiber diameter in a range from 625 nm to 800 nm at a relative frequency, as determined by means of the method disclosed in the description, of at least 20%, for example from 20% to 60%, more preferably from 20% to 50%, more preferably from 20% to 40%, in particular from 25% to 35%.

In a particularly preferred embodiment, the polypropylene fibers have a fiber diameter in a range from 400 nm to 575 nm at a relative frequency, as determined by means of the method disclosed in the description, of from 20% to 60%, preferably of at least 25%, for example from 25% to 60%, more preferably from 25% to 55%, more preferably from 30% to 50%, in particular from 35% to 45%, and a fiber diameter in a range from 625 nm to 800 nm at a relative frequency, as determined by means of the method disclosed in the description, of from 20% to 50%, more preferably from 20% to 40%, in particular from 25% to 35%.

Preferably, the polypropylene fibers have a fiber diameter in a range from 400 nm to 600 nm, preferably from 400 nm to 575 nm, at a higher relative frequency, as determined by means of the method disclosed in the description, than a fiber diameter in a range from >600 nm to 800 nm, preferably from 625 nm to 800 nm.

The filter material can also contain further PP fibers, the fiber diameter of which is not in one of the ranges from 400 to 600 nm and >600 to 800 nm. The fiber diameter of these further PP fibers is preferably less than 5 μm, preferably less than 4 μm, more preferably less than 3 μm, more preferably less than 2.5 μm, in particular less than 2 μm, in order to further improve the filtering action of the filter material without causing a substantial increase in pressure difference.

Preferably, the polypropylene fibers have a fiber diameter in a range from 700 nm to 1000 nm at a relative frequency, as determined by means of the method disclosed in the description, of at least 20%, for example from 20% to 60%, preferably of at least 25%, for example from 25% to 60%, more preferably from 25% to 55%, more preferably from 30% to 50%, in particular from 35% to 45%.

Further preferably, the polypropylene fibers have a fiber diameter in a range from <400 nm, preferably from 10 nm to 390 nm, more preferably from 50 nm to 390 nm, more preferably from 100 nm to 390 nm, at a relative frequency, as determined by means of the method disclosed in the description, of at least 15%, for example from 15% to 40%, more preferably from 20% to 35%, more preferably from 20% to 30%.

A fiber diameter distribution of melt-blown PP fibers as indicated for the filter material according to the disclosure has proved to lead to a particularly high filter action and thus very good filter efficiency, with the increase in pressure difference being drawn out at the same time, thus affording the filter material a long service life and consequently lengthening the intervals between replacements.

In addition to submicron PP fibers, the first layer in the fiber material according to the disclosure may also comprise further fiber materials or other filter aids, for example in order to separate out not only particles but also other harmful substances, for instance gases, bacteria, or viruses.

On account of the simplified production alongside a very good filtering action and a simultaneous low increase in pressure difference, it is advantageous for the first layer to consist of melt-blown polypropylene fibers having a fiber diameter of less than 5 μm, the polypropylene fibers having a fiber diameter in a range from 400 nm to 600 nm at a relative frequency, as determined by means of the method disclosed in the description, of at least 20%, for example from 20% to 60%, and a fiber diameter in a range from >600 nm to 800 nm at a relative frequency, as determined in the description, of at least 20%, for example from 20% to 60%. Such a filter material is particularly suitable for filtering particles from air. The filter material according to the disclosure can be stacked to form multiple layers and/or combined with other filter materials. The filter action can thus be adjusted in a targeted manner. In a preferred embodiment, all the melt-blown polypropylene fibers have a fiber diameter of less than 5 μm.

According to a further advantageous development, the first layer has a mass per unit area in a range from 5 to 20 g/m² and in particular from 6 to 15 g/m². The mass per unit area is measured by means of EN 29073-1:1992. A mass per unit area in a range from 5 to 20 g/m² has proved advantageous in light of an improvement in the filtering action, which can be further improved by shifting the mass per unit area toward higher values. Above a mass per unit area of more than 15 g/m², and in particular of more than 20 g/m², however, a slight increase in pressure difference can occur; this can be particularly readily avoided if the mass per unit area is limited to at most 15 g/m².

In order to increase the separation rate or adsorption rate of particles by the filter material, and thus to further improve the filtering performance, the first layer preferably has a layer thickness in a range from 10 μm to 200 μm, in particular from 20 μm to 150 μm, and in particular from 40 μm to 80 μm. The layer thickness is determined in accordance with DIN EN ISO 9073-2:1996, the measurement being conducted as follows: The fiber layer composed of submicron melt-blown PP fibers is loaded using a plunger having a surface area A of 10 cm² and a force of 12.5 cN, the measured thickness value being read off in mm in the compressed region. The higher the layer thickness, the higher the filter efficiency and thus the adsorption rate of the filter. However, the costs for the filter material are also accordingly higher. With a view to a trade-off between the above effects, a layer thickness of the first layer in a range from 40 μm to 80 μm has proved particularly advantageous.

Further advantageously, the filter material comprises a first substrate, the first layer being arranged on the first substrate and, in particular, the melt-blown PP fibers being deposited on the first substrate. The advantage of using a first substrate is that the filter material is additionally mechanically stabilized. The first substrate also protects the PP fibers from soiling while the filter material is being stored or transported. The substrate has proved particularly advantageous for laying the melt-blown PP fibers, as they can be directly deposited on the substrate in layers, thereby avoiding having to rearrange the PP fibers multiple times. In a preferred embodiment, the first layer and the first substrate are connected to one another by calendering. This increases the adhesion of the two layers to one another.

In order to improve the filter action, the first substrate is advantageously selected from at least one of a spunbond fabric, wet-laid nonwoven, staple fiber nonwoven, laid nonwoven, warp-knitted fabric, woven fabric, weft-knitted fabric, and combinations thereof. The above fabrics are characterized by a certain porosity so that particles can pass through them in order to be separated out by the first layer.

In the context of a trade-off between high filter action and low increase in pressure difference, it has also proved advantageous for the mass per unit area of the first substrate to be in a range from 8 g/m² to 35 g/m² and preferably in a range from 10 to 25 g/m² and in particular in a range from 10 to 20 g/m². The mass per unit area is again determined as described above for the first layer. If the mass per unit area of the first substrate is in a range from 8 to 35 g/cm², the filter performance is not adversely affected. In addition, a mass per unit area of the first substrate in a range from 10 to 25 g/m² improves the mechanical stability of the filter material and particularly efficiently protects the first layer against being soiled and damaged during storage and transport.

In order to further improve the mechanical stability, the first substrate preferably has a layer thickness in a range from 50 to 400 μm, more preferably in a range from 100 to 300 μm, and in particular in a range from 200 to 300 μm. In this case, the layer thickness is measured as described for the layer thickness of the first layer. The higher the layer thickness of the first substrate, the greater the stability of the filter material. However, a disadvantage of a high layer thickness of the first substrate is that it introduces additional weight and volume to the filter material, and therefore the layer thickness of the first substrate is advantageously in a range from 100 to 300 μm and in particular from 200 to 300 μm. This means that the increase in pressure difference is not substantially raised either.

Particularly preferably, the composite formed of the first substrate and the first layer has a layer thickness in a range from 50 to 400 μm, more preferably in a range from 100 to 300 μm, and in particular in a range from 200 to 300 μm. In this case, the layer thickness is measured as described for the layer thickness of the first layer.

In order to optimize adhesion between the first substrate and the first layer, the material of the first substrate is preferably a polyolefin, and in particular is polypropylene (PP). In this case, the PP does not have to be identical to the PP of the melt-blown PP fibers, but in particular it has a melting range similar to the melting range of the melt-blown PP fibers.

The filter material comprising at least one first layer as described above and a first substrate is highly suitable as a filter medium, in order for example to filter particles from air or else from liquids, but in particular from air. All dust particles that are commonly present in the air, for instance pollen, soot, and cigarette smoke, can be removed from the air using the filter material according to the disclosure, with the dust particles accumulating on the filter network composed of the melt-blown PP fibers.

In order to improve handling and to create as broad a field of use as possible in addition to achieving very good filter efficiency with a low increase in pressure difference, the filter material preferably has a layer thickness, measured in the same way as the layer thickness of the first layer, in a range from 60 to 600 μm, more preferably in a range from 100 to 400 μm, and in particular in a range from 200 to 300 μm.

Furthermore, for a balanced profile of properties between filter effectiveness and minimizing increases in pressure difference, it is further advantageous if the filter material has a mass per unit area in a range from 10 to 50 g/m², and in particular from 15 to 40 g/m². The mass per unit area is measured by means of EN 29073-1:1992.

According to a further preferred embodiment, the filter material has an air permeability of 400 to 500 l/m²·s. The air permeability is measured according to DIN EN ISO 9237:1995, with the measurement pressure being 200 Pa and the measurement surface area being 20 cm². When the air permeability of the filter is in a range from 400 to 500 l/m²·s, the filter material has a high throughput rate and can filter large quantities of air in a short time. This is particularly advantageous if the filter material is used in an area where there is a relatively high spatial volume.

In order to improve the filter efficiency, the filter material further advantageously comprises activated charcoal. The activated charcoal is not particularly limited but is preferably obtained from renewable raw materials and in particular from coconut shells. Activated charcoal from coconut shells has proved advantageous, particularly on account of its high hardness and thus good strength, and also has a particularly good adsorption capacity for n-butane, which is a component of engine fuels. On account of the large active surface area of the activated charcoal, a filter material according to the disclosure which has activated charcoal is thus preferred particularly when the medium to be filtered has high quantities of particles or gases to be filtered out and when the particles have a very small particle diameter. According to one advantageous development, the activated charcoal is particularly advantageously used for separating gases.

The filter material preferably has a second layer containing activated charcoal. The second layer is preferably arranged on the first layer. This gives rise to a sequence of layers: first substrate/first layer/second layer. Providing the activated charcoal in the form of a second layer makes it possible to adjust the filter properties in a more targeted manner, since factors such as layer thickness, mass per unit area, and also air permeability can be adjusted independently of one another. Thus, the filter material can be tailored to a specific application using the composition of the layers.

For example, the second layer can be deposited directly on the first layer. Advantageously, however, the filter material comprises a second substrate on which the second layer is arranged. This means the activated charcoal filter can be produced and handled separately. Depending on the type of connection between the second layer and the first layer, the corresponding layer can also be replaced as required, for example when the maximum adsorption capacity has been reached. This results, for this advantageous development, in an arrangement of layers as follows: first substrate/first layer/second layer/second substrate.

The first and the second layer can be connected to one another, for example by means of lamination or adhesive bonding, and can optionally comprise auxiliaries for this purpose.

The second substrate can be formed like the first substrate. In particular, the second substrate is selected from at least one of a spunbond fabric, a wet-laid nonwoven, a staple fiber nonwoven, a laid nonwoven, a warp-knitted fabric, a woven fabric, a weft-knitted fabric, and combinations thereof.

On account of the very good mechanical and chemical stability, the material of the second substrate is preferably a polyolefin, and in particular is polypropylene.

So as not to impair the filter action, but rather to improve it, the second substrate preferably has a mass per unit area in a range from 20 to 100 g/m² and in particular from 40 to 80 g/m². The mass per unit area is measured by means of EN 29073-1:1992. When the mass per unit area is particularly low, i.e., preferably 40 g/m² and further preferably 20 g/m², the filter material is characterized by improved passage of air when the filter material is used as an air or gas filter. Higher masses per unit area, in particular of more than 80 g/m² or even more than 100 g/m², may be disadvantageous with respect to “clogging” of the filter, i.e., rapidly reaching the maximum adsorption capacity. For the above reasons, a mass per unit area of the second substrate of 40 to 80 g/m² is particularly advantageous.

The layer thickness of the second substrate is substantially not limited but, on account of the mechanical stability of the filter material, is preferably in a range from 200 to 800 μm and more advantageously in a range from 450 to 600 μm. Very high layer thicknesses of more than 600 μm or even of more than 800 μm may be disadvantageous in respect of different fields of use which require filter materials of small dimensions. The layer thickness is measured like the layer thickness of the first substrate, and reference can be made to the method indicated above.

For a high filter performance, i.e., large throughput volumes, it is also advantageous for the second substrate to have an air permeability of from 1500 to 6000 l/m²·s, preferably from 2000 to 4500 l/m²·s. The air permeability is again measured by means of DIN EN ISO 9237:1995, using a measurement pressure of 100 Pa and a measurement surface area of 20 cm².

According to a further advantageous development, in order to further improve the adsorption capacity of the filter material according to the disclosure, the activated charcoal has a particle size for screen sizes from 20×50 mesh to 60×150 mesh and in particular from 30×60 to 60×120 mesh. If the particle size is in one of the above-mentioned ranges, the activated charcoal is particularly suitable for the adsorption of n-butane, which is used as a tracer gas in the automotive sector.

The filter efficiency can further advantageously be increased by the second layer comprising hot-melt adhesive threads. In this case, the hot-melt adhesive threads (4) and the activated charcoal have preferably been applied together to the second substrate. A hot-melt that is suitable for the filter material of the present disclosure is a thermoplastic material which has a softening point of from 115 to 170° C. and in particular from 120 to 165° C. The softening points were measured in accordance with DIN 51920 (version: 1984), with a lead ball being placed on the surface of the adhesive, and the adhesive being pressed by the nipple. The lead ball has a weight of 3.2+/−0.2 g (32 caliber), and the nipple has a 6.35-mm hole for receiving the molten hot-melt. A hot-melt that is suitable for the filter material of the present disclosure further has adhesive properties at the intended temperature of use of the filter material. Not only can the hot-melt adhesive threads additionally bind in particular coarser particles, they can also protect and fix the activated charcoal layer, i.e., the second layer. The hot-melt adhesive threads are advantageously in the form of a surface-tacky adhesive web. This tacky adhesive web can also be referred to as a web-like adhesion layer, which is a component of the second layer and, due to its tackiness, can cause additional separation of substances to be filtered. The surface tackiness of a hot-melt can be increased, for example, by the targeted addition of tackifiers.

The hot-melt adhesive threads are preferably polyolefinic hot-melt adhesive threads, in particular amorphous poly-alpha-olefinic hot-melt adhesive threads. Further preferably, the hot-melt adhesive threads have a diameter of from 5 to 60 μm, preferably from 20 to 40 μm. Particular preference is given to poly-alpha-olefinic hot-melt adhesive threads based on propylene. The hot-melt adhesive threads advantageously make it possible especially for coarser dust particles to accumulate and be filtered out, thereby protecting the subsequent layers.

This results, for this advantageous development, in an arrangement of layers as follows: first substrate/first layer/second layer containing hot-melt adhesive threads/second substrate. A filter material formed in this way has a very high filter capacity, in particular for particles of all sizes, which are filtered out by the various layers. To this end, the filter material preferably has a layer thickness in a range from 500 to 2500 μm, more preferably from 800 to 2000 μm and in particular from 1500 to 1800 μm, with the layer thickness being determined using a dial gauge (Mitutoyo 543-271B) in a measurement range up to 12.7 mm, at a resolution of 0.01 mm, a measurement force of 1.5 N, a plunger diameter of 12 mm with a bearing surface of 113.1 mm², and a plunger weight of 15 g.

This filter material preferably has a mass per unit area, measured by means of EN 29073-1:1992, in a range from 250 to 500 g/m² and in particular in a range from 300 to 400 g/m². This makes it possible to minimize any increase in pressure difference while having very good filter efficiency, and it means that the filter material can be used in virtually all fields of use, in particular for air purification.

A further advantageous development is characterized in that the filter material has an air permeability of 100 to 150 l/m²·s. This maximizes the filter capacity, i.e., the throughput volume of the medium to be filtered, while at the same time providing very high filter efficiency. The air permeability of the filter material is again measured as described in DIN EN ISO 9237:1995, with a measurement pressure of 200 Pa and a measurement surface area of 20 cm².

The filter material can further advantageously further comprise an electret pre-filter. This makes it possible to increase the initial filter efficiencies. The electret pre-filter can in particular be connected to the first substrate or to the second substrate, in particular by lamination, adhesive bonding, or for example also by ultrasonic welding. According to the present disclosure, an electret pre-filter means a filter layer that is electrostatically charged, for example by means of corona or high-voltage technology. As a result, the dust holding capacity can also be further improved.

An air filter (hereinafter, this term also covers a gas filter, for instance also an exhaust gas filter), a water filter, or a particle filter is also described according to the disclosure, said filter comprising the filter material disclosed above. On account of the use of the filter material according to the disclosure, an air filter, water filter, or particle filter formed in this way is characterized by a high separation rate of particles with a simultaneous long period of use, and thus long intervals between replacements, owing to the low increase in pressure difference.

Furthermore, a method for producing a filter material is also described according to the disclosure. The filter material can be the filter material described above. In other words, the method according to the disclosure can be used to produce the filter material according to the disclosure.

The method first comprises a step of producing a polypropylene melt, the polypropylene for the polypropylene melt having a melt flow rate (MFR) of from 800 to 4000 g/10 min, and in particular from 1100 to 2800 g/10 min. It is therefore a low-viscosity polypropylene. It should be understood that use can be made here of one type of polypropylene or two or more types of polypropylene that may differ, for example, on account of their tacticity, molecular weight, or polydispersity. It is advantageous here if, when two or more types of polypropylene are used in combination, the melt flow rate of each individual type of polypropylene is in a range from 800 to 4000 g/10 min. The melt flow rate (MFR) is measured by means of ISO 1133-1 (2022). The melting of the polypropylene to produce the polypropylene melt takes place in particular at a temperature of from 200 to 300° C. This is advantageous because the melt thus becomes thinner and can be drawn out more readily.

The polypropylene melt can be used directly as a melt-blowing mixture for melt blowing. Preferably, however, at least one sterically hindered hydroxylamine ester is added to the polypropylene melt and mixed with the polypropylene melt, thereby producing a melt-blowing mixture containing a hydroxylamine ester. In this case, a content of the sterically hindered hydroxylamine ester in the melt-spinning solution is preferably in a range from 0.1 to 5, preferably 0.1 to 3 wt. %, in particular 0.1 to 2.5 wt. %, relative to the total weight of the melt-blowing mixture. Various suitable sterically hindered hydroxylamine esters are commercially available and are preferably offered in the form of mixtures with one or more polymers. Use may, for example, be made of Irgatec® CR 25 or Irgatec® CR 76 from Badische Anilin- & Soda-Fabrik (BASF).

Then, the melt-blowing mixture is melt blown, the spun polypropylene fibers are stretched using air at a temperature of at least 240° C. (measured at the spinneret), for example 240° C. to 300° C., and then laid on a first substrate, producing a polypropylene filter layer.

The melt blowing results in melt-blown PP fibers, the polypropylene fibers having a fiber diameter in a range from 400 nm to 600 nm at a relative frequency, as determined by means of the method disclosed in the description, of at least 20%, for example from 20% to 60%, preferably of at least 25%, for example from 25% to 60%, more preferably from 25% to 55%, more preferably from 30% to 50%, in particular from 35% to 45%, and a fiber diameter in a range from >600 nm to 800 nm at a relative frequency, as determined by means of the method disclosed in the description, of at least 20%, preferably from 20% to 60%, more preferably from 20% to 50%, more preferably from 20% to 40%, in particular from 25% to 35%. The diameter of the PP fibers can be adjusted by means of the melt flow rate (MFR) of the polypropylene and by means of the content of the at least one sterically hindered hydroxylamine ester used to produce the spin melt. The temperature of the air used for stretching is at least 240° C. (measured at the spinneret), for example 240° C. to 300.

The melt blowing of the PP fibers can, for example, be carried out in a melt-blowing plant, applying the following parameters:

| Spinneret temperatures | 275° | C. |
|---|---|---|
| Primary air temperature | 280° | C. |
| Primary air quantity | 1000 m³/hxm (per hour and per | |
| | meter of spinneret length) | |
| DCD (die-to-collector distance) | 300 | mm |

The method can be implemented simply and without a great deal of technical complexity and serves to produce a filter material having high filter efficiency, good filter capacity, and very low increase in pressure difference.

The advantages, advantageous effects, and developments described for the filter material according to the disclosure also apply to the method according to the disclosure for producing a filter material.

According to one advantageous development, the method according to the disclosure also comprises a step of producing an activated charcoal filter layer, with activated charcoal first being applied to a second substrate, and hot-melt adhesive threads then being deposited on the activated charcoal.

In addition, the activated charcoal layer is connected to the polypropylene filter layer, thereby forming the following arrangement of layers: second substrate/activated charcoal layer containing hot-melt adhesive threads (second layer)/polypropylene filter layer (first layer)/first substrate.

This advantageous development makes it possible to further improve the filter performance because the activated charcoal introduces an additional adsorption volume with a high adsorption surface area into the filter material, and in particular gases, for instance butane, can also be filtered out.

The use of melt-blown polypropylene fibers as a filter material layer is also described according to the disclosure, the polypropylene fibers having a fiber diameter in a range from 400 nm to 600 nm at a relative frequency, as determined by means of the method disclosed in the description, of at least 20%, for example from 20% to 60%, preferably of at least 25%, for example from 25% to 60%, more preferably from 25% to 55%, more preferably from 30% to 50%, in particular from 35% to 45%, and a fiber diameter in a range from >600 nm to 800 nm at a relative frequency, as determined by means of the method disclosed in the description, of at least 20%, preferably from 20% to 60%, more preferably from 20% to 50%, more preferably from 20% to 40%, in particular from 25% to 35%.

In the aforementioned use, the filter material layer further advantageously has a mass per unit area, measured by means of EN 29073-1:1992, in a range from 5 to 20 g/m², in particular from 6 to 15 g/m².

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a section of a filter material according to a first embodiment;

FIG. 2 is a graph illustrating the efficiency of a second embodiment of the filter material, plotted against the particle size of the particles to be filtered;

FIG. 3 is a graph illustrating the dust retention capacity after an increased pressure drop of 100 Pa; and

FIG. 4 is a scanning electron microscopy (SEM) image of the top view of a filter material.

Further details, advantages, and features of the present disclosure will become clear from the following description of exemplary embodiments with reference to the drawings.

### DETAILED DESCRIPTION

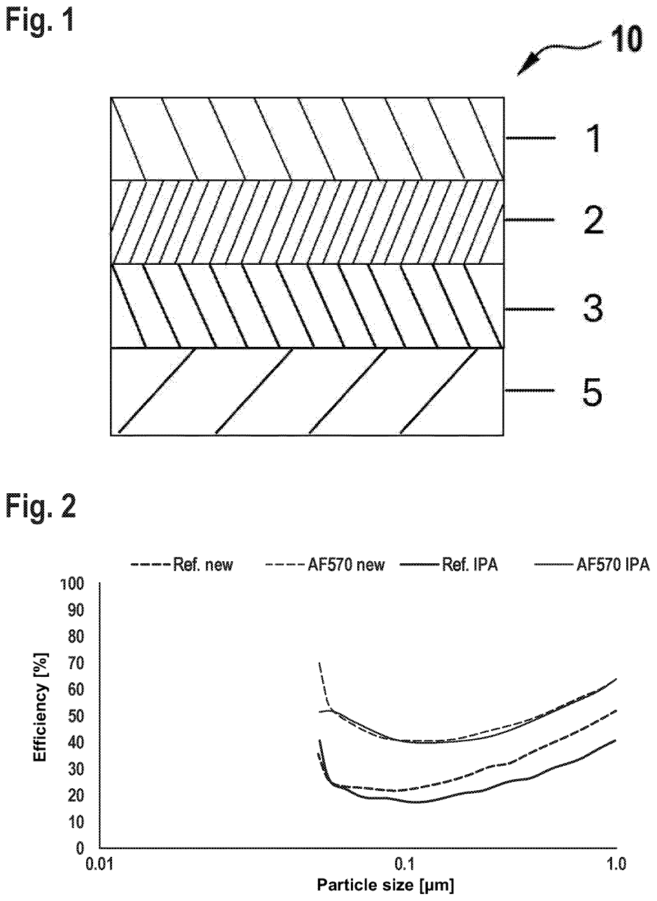

FIGS. 1-3 show just the essential elements and components of the advantageous aspects according to the disclosure. All other elements and components have been omitted for clarity. In addition, the same reference numerals denote the same constituents, elements, or components.

FIG. 1 shows a filter material 10 according to an advantageous embodiment in detail. The filter material 10 is shown in section and has the following arrangement of layers:
first substrate 1, first layer 2, second layer 3, second substrate 5.

The first substrate 1 is preferably a spunbond fabric having a mass per unit area of 10 to 20 g/m², measured by means of EN 29073-1:1992, and consists of polypropylene. It has a layer thickness in a range from 200 to 300 μm, with the layer thickness being measured by loading the spunbond fabric using a plunger having a surface area A of 10 cm² and a force of 12.5 cN, the measured thickness value being read off in mm (hereinafter: ITM=internal measurement method in accordance with DIN EN ISO 9073-2:1996). The fiber diameter of the first substrate is advantageously in a range from 20 to 30 μm.

The first layer 2 is formed of melt-blown polypropylene fibers, the polypropylene fibers having a fiber diameter in a range from 400 nm to 600 nm at a relative frequency, as determined by means of the method disclosed in the description, of at least 20%, and a fiber diameter in a range from >600 nm to 800 nm at a relative frequency, as determined by means of the method disclosed in the description, of at least 20%. The fiber diameter is determined using SEM images (2000× magnification), as set out in the “Measurement Methods” section. The submicron PP fibers having the specific fiber diameter distribution achieve a high filter capacity with a simultaneous low increase in pressure difference, and therefore the filter material 10 is characterized by long-lasting, very high adsorption properties and thus long intervals between replacements.

There is high adhesion between the PP fibers of the first layer 2 and the first substrate 1 owing to the use of the same chemical material. In addition, the PP fibers are directly deposited on the first substrate 1 by melt spinning, thereby achieving an even better layer composite.

The next layer is a second layer 3, an activated charcoal layer containing activated charcoal. This improves the adsorption rate, in particular for particles of a small particle size and gases, because the activated charcoal has a large adsorption surface area.

In addition to the activated charcoal, the second layer 3 contains a web of hot-melt adhesive threads formed of PP, which have a melting range of approximately 110° C. The hot-melt adhesive threads were deposited directly on the activated charcoal of the second layer 3, thereby fixing and protecting the activated charcoal. Owing to their tackiness, the hot-melt adhesive threads 4 can in particular filter out particles having a large particle diameter. The activated charcoal and the layer of hot-melt adhesive threads 4 form a common heterogeneous layer, i.e., a single unit (second layer 3).

Reference numeral 5 denotes a second substrate which can be formed like the first substrate 1 and in particular is also formed of PP. It serves as a carrier for the activated charcoal, contributes to the mechanical protection of the filter material 10, and is formed with a mass per unit area, layer thickness, and air permeability such that the filter efficiency is not impaired and also no increase in pressure difference is introduced thereby.

FIG. 2 is a graph illustrating the efficiency of a second embodiment of the filter material plotted against the particle size of the particles to be filtered.

The filter material was produced as follows:

First, a polymer melt was produced by melting a metallocene-catalyzed PP (MFR 1800 g/10 min, according to ISO 1133-1 at 230° C.). Subsequently, Irgatec® CR 25 (manufacturer: BASF), a sterically hindered hydroxylamine ester in a PP matrix, was added continuously, such that the content of the sterically hindered hydroxylamine ester in the melt-blowing mixture was in a range from 0.1 to 2.5 wt. % relative to the total weight of the melt-blowing solution. The PP matrix is not included in the determination of the content of hydroxylamine ester.

Processing took place at 250° C. This means that the aforementioned melt-blowing mixture of PP and Irgatec® CR 25 was spun at a temperature of approximately 250° C. and spun out to give a PP spunbond fabric having a mass per unit area of 15 g/m² as the first substrate, with the fibers additionally being stretched by means of hot air during the spinning (in this case approximately 280° C.=primary air temperature).

A melt-blowing plant was used for this purpose, applying the following parameters:

| Spinneret temperatures | 275° | C. |
|---|---|---|
| Primary air temperature | 280° | C. |
| Primary air quantity | 1000 m³/hxm (per hour and per | |
| | meter of spinneret length) | |
| DCD (die-to-collector distance) | 300 | mm |

The PP spunbond fabric had a layer thickness, as measured for the first substrate in FIG. 1, of 0.20 mm. The resulting two-layer laminate had a layer thickness of 0.26 mm, a mass per unit area (measured by means of EN 29073-1:1992) of 25 g/m², and an air permeability, measured by means of DIN EN ISO 9237:1995 at a measurement pressure of 200 Pa and a measurement surface area of 20 cm², of 450 l/m²·s. The two material layers were calendered for improved adhesion.

The layer thickness of the melt-blown PP fiber layer (polypropylene filter layer) was thus 0.06 mm, and the fiber diameters of the individual filaments obtained were determined as per the “Measurement Methods” section. It was found that all the fibers had a fiber diameter of less than 5 μm, and the fibers had a fiber diameter in a range from 400 nm to 600 nm at a relative frequency, as determined by means of the method disclosed in the description, of at least 20%, and a fiber diameter in a range from >600 nm to 800 nm at a relative frequency, as determined by means of the method disclosed in the description, of at least 20%.

In a second step, an activated charcoal filter layer was produced using the above polypropylene filter layer as a covering material. The second substrate used was a PP spunbond fabric having a mass per unit area of 60 g/m², a layer thickness of 0.45 mm, and an air permeability of 2650 (100 Pa)l/m²·s, measured by means of DIN EN ISO 9237:1995 at a measurement pressure of 100 Pa and a measurement surface area of 20 cm², which was coated with an activated charcoal having a mass per unit area of 230 g/m² (30×60 mesh particle size, based on coconut shells) and PP hot-melt adhesive threads (Jowatherm® 238.75) and was equipped with the above two-layer covering material. The diameter of the hot-melt filaments was 10-20 μm.

The activated charcoal laminate obtained had the following technical data: Mass per unit area, measured by means of EN 29073-1:1992, of 370 g/m², a layer thickness of 1.60 mm, and an air permeability, measured by means of DIN EN ISO 9237:1995 at a measurement pressure of 100 Pa and a measurement surface area of 20 cm², of 130 l/m²·s.

A similarly structured activated charcoal laminate served as reference, having a commercially available nanofiber medium (polyester spunbond fabric substrate having a mass per unit area of 30 g/m², polyvinylidene difluoride (PVDF) nanofibers (fiber diameter of less than 100 nm), and a polyester cover having a mass per unit area of 30 g/m²), having an overall mass per unit area of 60 g/m², a layer thickness, measured by means of ITM, of 0.22 mm, and an air permeability, measured by means of DIN EN ISO 9237:1995 at a measurement pressure of 200 Pa and a measurement surface area of 20 cm², of 425 l/m²·s.

For the technical filter tests (fractional separation efficiency=efficiency based on particle size and dust holding capacity), DIN 71460-1-2006 applies (Road vehicles—Air filters for motor passenger compartments—Part 1: Test for particulate filtration), which describes the apparatuses and test methods required, with the addition of DIN 71460-3-2020-10 (Road vehicles—Air filters for passenger compartments—Part 3: PMx based filter efficiency eff (PMx)) indicating the use of the di-ethyl-hexyl sebacate (DEHS) aerosol. Thus, the test was carried out using DEHS aerosol. The dust used for dust testing, Society of Automotive Engineers (SAE) Fine Staub, is comparable to the A.2 Fine Test Dust described in ISO 12103-1:2016(E).

FIG. 2 shows four curves. “Ref new” is the commercial nanofiber filter material that served as a reference, and “AF570 new” corresponds to the filter material according to the disclosure, the production of which is described at the beginning of the description of FIG. 2. Both of the curves denoted “IPA” are curves obtained after the respective filters were discharged using isopropanol. FIG. 2 shows that the filter material according to the disclosure has higher efficiency across all particle sizes.

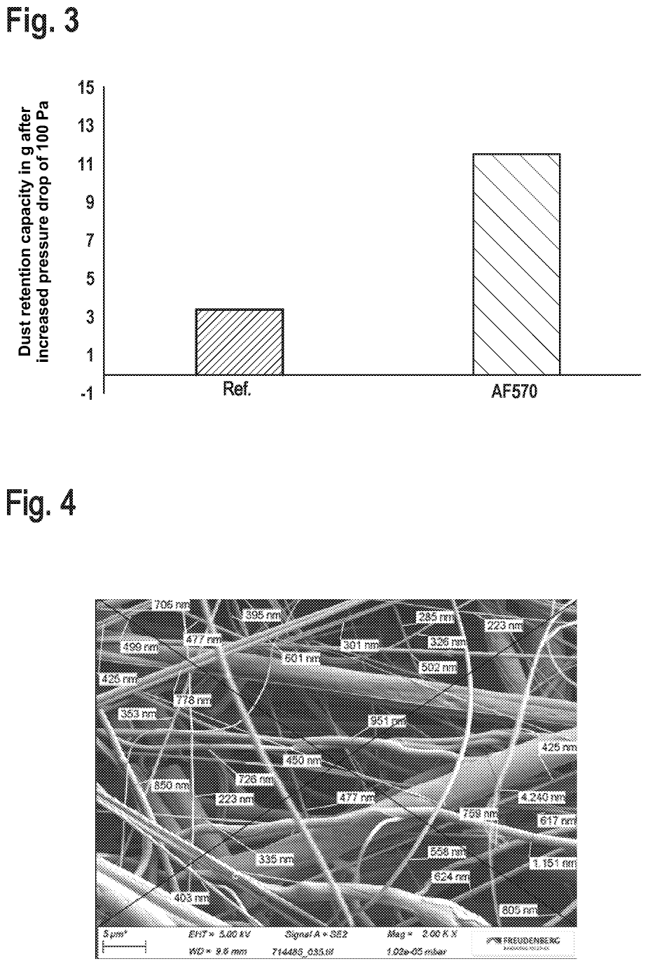

FIG. 3 is a graph showing the dust retention capacity of the reference filter material (Ref.) and the filter material according to the disclosure (AF570) after an increased pressure drop of 100 Pa. In detail, FIG. 3 shows that, after an increased pressure drop, the dust retention capacity of the filter material according to the disclosure is an order of magnitude higher than that of the reference filter material.

FIG. 4 shows a SEM image of the top view of a filter material. The relative frequency of the fiber diameter of the polypropylene fibers was determined using the method described in the “Measurement Methods and Standards” section. The following results were obtained:

$$400 nm to 600 nm = 34 \%$$

$$600 nm to 80 nm = 24 \%$$

$$Others = 24 \%$$

To complement the disclosure of the disclosure, in addition to the written description of the disclosure above, reference is explicitly made here to the illustration thereof in the figures.

### Measurement Methods and Standards

### Relative Frequency of the Fiber Diameter of the Polypropylene Fibers

According to the disclosure, the relative frequency of the fiber diameter of the polypropylene fibers is determined as follows. The top view of an A4 sample of a filter material according to the disclosure is observed. If the first layer is covered by an outer layer, for example because a cover or a first substrate is arranged thereon, the first layer is revealed by careful peeling back using tweezers. To prevent charging during the subsequent measurement, the surface is sputtered. SEM (Scanning Electron Microscope) images of 40 different measurement positions over the surface (randomly distributed; only those measurement positions that showed at least 30 fibers that could be differentiated from one another and were in focus were taken into consideration) were taken at 2000× magnification and a resolution of 1024 by 768 pixels.

The relative frequency of the fiber diameter is determined by placing two diagonal lines on each image starting at the corners. Only the fiber diameters of those polypropylene fibers that are intersected by at least one of the two diagonal lines are taken into consideration. The fiber diameter is measured at the point of intersection with the diagonal line. If a polypropylene fiber intersects both diagonals, or one diagonal multiple times, only one value is incorporated in the calculation. Firstly, the total number of fiber diameters ascertained is determined. This corresponds to the number of all polypropylene fibers that intersect with at least one of the two diagonals (reference number). In the next step, the number of fiber diameters in a range from 400 nm to 600 nm, and the number of fiber diameters in a range from >600 nm to 800 nm, are ascertained from the total number of ascertained fiber diameters (reference number). Dividing the number of fiber diameters in the relevant range by the total number of ascertained fiber diameters, and multiplying by 100, gives the relative frequency [%] of that fiber diameter. The average over the results of the images investigated is calculated.

### Melt Flow Rate (MFR)

First, a polypropylene melt is produced by melting a metallocene-catalyzed PP (MFR 1800 g/10 min, measured by means of ISO 1133-1). The heated sample is loaded with a weight of 2.16 kg at 230° C., and the amount discharged over a period of 10 minutes is determined.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

LIST OF REFERENCE NUMERALS

| | |
|---|---|
| 1 | First substrate |
| 2 | First layer |
| 3 | Second layer |
| 5 | Second substrate |
| 10 | Filter material |

What is claimed is:

1. A filter material comprising
a first layer comprising melt-blown polypropylene fibers which have a fiber diameter in a range from 400 nm to 600 nm at a relative frequency of at least 20%, and a fiber diameter in a range from >600 nm to 800 nm at a relative frequency of at least 20%.

2. The filter material according to claim 1, wherein the first layer consists of melt-blown polypropylene fibers having a fiber diameter of less than 5 μm, wherein the polypropylene fibers have a fiber diameter in a range from 400 nm to 600 nm at a relative frequency of from 20% to 60%, and a fiber diameter in a range from >600 nm to 800 nm at a relative frequency of from 20% to 60%.

3. The filter material according to claim 1, wherein the first layer has a layer thickness in a range from 10 μm to 200 μm.

4. The filter material according to claim 1, further comprising a first substrate,
wherein the first layer is arranged on the first substrate and wherein the polypropylene fibers are deposited on the first substrate,
wherein the first substrate is selected from at least one of a spunbond fabric, wet-laid nonwoven, staple fiber nonwoven, laid nonwoven, warp-knitted fabric, woven fabric, weft-knitted fabric, and combinations thereof.

5. The filter material according to claim 1, wherein the filter material has a layer thickness in a range from 60 to 600 μm.

6. The filter material according to claim 1, further comprising a second layer comprising activated charcoal, wherein the second layer is arranged on the first layer.

7. The filter material according to claim 6,
wherein the filter material comprises a second substrate and wherein the second layer is arranged on the second substrate,
wherein the second substrate is selected from at least one of a spunbond fabric, wet-laid nonwoven, staple fiber nonwoven, laid nonwoven, warp-knitted fabric, woven fabric, weft-knitted fabric, and combinations thereof.

8. The filter material according to claim 7, wherein the second substrate has a layer thickness in a range from 200 μm to 800 μm.

9. The filter material according to claim 6, wherein the activated charcoal has a particle size for screen sizes from 20×50 mesh to 60×150 mesh.

10. The filter material according to claim 6,
wherein the second layer comprises hot-melt adhesive threads,
wherein the hot-melt adhesive threads and the activated charcoal were applied together to the second substrate.

11. The filter material according to claim 7, comprising the following arrangement of layers:
first substrate/first layer/second layer/second substrate,
wherein the filter material has a layer thickness in a range from 500 to 2500 μm.

12. The filter material according to claim 1, wherein the melt-blown polypropylene fibers have a fiber diameter in a range from 400 nm to 600 nm at a relative frequency of 20% to 60% and a fiber diameter in a range from >600 nm to 800 nm at a relative frequency of 20% to 60%.

13. The filter material according to claim 2,
wherein the melt-blown polypropylene fibers have a fiber diameter in a range from 400 nm to 600 nm at a relative frequency of 20% to 60% and a fiber diameter in a range from >600 nm to 800 nm at a relative frequency of 20% to 60%;
wherein the first layer has a layer thickness in a range from 10 μm to 200 μm; and
wherein the filter material further comprises a first substrate, wherein the first layer is arranged on the first substrate and wherein, in particular, the polypropylene fibers are deposited on the first substrate,
wherein the first substrate is selected from at least one of a spunbond fabric, wet-laid nonwoven, staple fiber nonwoven, laid nonwoven, warp-knitted fabric, woven fabric, weft-knitted fabric, and combinations thereof.

14. The filter material according to claim 9, wherein the activated charcoal has a particle size for screen sizes from 30×60 to 60×120 mesh.

15. The filter material according to claim 10, wherein the material of the hot-melt adhesive threads is at least one polyolefin.

16. The filter material according to claim 10, wherein the material of the hot-melt adhesive threads is polypropylene.

17. An air filter, water filter, or particle filter, comprising the filter material according to claim 1.

18. A method for producing a filter material, the method comprising the steps of:
producing a polypropylene melt, wherein the polypropylene has a melt flow rate (MFR) of from 800 to 4000 g/10 min,
adding at least one sterically hindered hydroxylamine ester, thereby obtaining a melt-blowing mixture having a content of the sterically hindered hydroxylamine ester in the melt-blowing mixture in a range from 0.1 to 5 wt. % relative to the total weight of the melt-blowing mixture,
melt blowing the melt-blowing mixture while stretching under air having a temperature of at least 240° C., measured at the spinneret, giving melt-blown polypropylene fibers, wherein the polypropylene fibers have a fiber diameter in a range from 400 nm to 600 nm at a relative frequency of at least 20%, and a fiber diameter in a range from >600 nm to 800 nm at a relative frequency of at least 20%, and
laying the spun polypropylene fibers on a first substrate, producing a polypropylene filter layer.

19. The method according to claim 18, further comprising the steps of:
producing an activated charcoal filter layer, comprising:
applying activated charcoal to a second substrate, and
laying hot-melt adhesive threads on the activated charcoal; and
connecting the activated charcoal filter layer to the polypropylene filter layer, thereby forming the following arrangement of layers:
second substrate/second layer and hot-melt adhesive threads/first layer/first substrate.

20. A method of using melt-blown polypropylene fibers, the method comprising manufacturing a filter material layer comprising a fiber diameter of less than 1 μm, wherein the polypropylene fibers have a fiber diameter in a range from 400 nm to 600 nm at a relative frequency of at least 20%, and a fiber diameter in a range from >600 nm to 800 nm at a relative frequency of at least 20%.
